(19) United States
(12) Patent Application Publication
(10) Pub. No.: US 2013/0273976 A1
(43) Pub. Date: Oct. 17, 2013

(54) Method and Apparatus for Identifying a Conversation in Multiple Strings

(71) Applicants: Jinghai Rao, Beijing (CN); Jilei Tian, Beijing (CN); Ye Tian, ChongQing (CN); Guan Wang, Xin-Jiang (CN)

(72) Inventors: Jinghai Rao, Beijing (CN); Jilei Tian, Beijing (CN); Ye Tian, ChongQing (CN); Guan Wang, Xin-Jiang (CN)

(73) Assignee: NOKIA CORPORATION, Espoo (FI)

(21) Appl. No.: 13/881,517

(22) PCT Filed: Oct. 27, 2010
(86) PCT No.: PCT/CN2010/078153

§ 371 Date: Jun. 3, 2013

(51) Int. Cl. G06F 17/27

(52) U.S. Cl. CPC G06F 17/2785
USPC 455/563; 704/9

(57) ABSTRACT

Techniques for identifying conversations in multiple short strings include determining from a first plurality of strings associated with a first contact of a user, based on time separations between successive strings, a first conversation portion and a different second conversation portion. The first conversation portion (snippet) comprises a plurality of strings of the first plurality; and the second snippet comprises a different pluralty of strings of the first plurality. A first semantic content for the first snippet and a second semantic content for the second snippet are determined. It is determined whether to merge the first snippet and the second snippet into a first conversation that includes the first snippet based, at least in part, on a similarity of the first semantic content to the second semantic content.

### BACKGROUND

Service providers and device manufacturers (e.g., wireless, cellular, etc.) are continually challenged to deliver value and convenience to consumers by, for example, providing compelling network services. A class of very popular services, including electronic mail (email), instant messaging (IM), short message service (SMS) and social network services, allows users to exchange messages with each other. The messages are organized typically by contact with which a user is exchanging messages and time of sending or delivering the message. In some circumstances, a user may prefer to group multiple messages from a contact based on topics of discussion, yet many of these services do not provide such options. Indeed, with services that have character limits on messages and no subject line, such as SMS and social networking services, it is difficult to ascertain the topic of an individual message.

### SOME EXAMPLE EMBODIMENTS

Therefore, there is a need for an approach for identifying a conversation in multiple strings.

According to one embodiment, a method comprises determining from a first plurality of strings associated with a first contact of a user, based on time separations between successive strings, a first conversation portion that comprises a plurality of strings of the first plurality and a different second conversation portion that comprises a different plurality of strings of the first plurality. The method also comprises determining a first semantic content for the first conversation portion and a second semantic content for the second conversation portion. The method further comprises determining whether to merge the first conversation portion and the second conversation portion into a first conversation that includes the first conversation portion based, at least in part, on a similarity of the first semantic content to the second semantic content.

According to another embodiment, a method comprises facilitating access to at least one interface configured to allow access to at least one service, the at least one service configured to perform all or part of the above method.

According to another embodiment, an apparatus comprises at least one processor, and at least one memory including computer program code, the at least one memory and the computer program code configured to, with the at least one processor, cause, at least in part, the apparatus to perform all or part of the above methods.

According to another embodiment, a computer-readable storage medium carries one or more sequences of one or more instructions which, when executed by one or more processors, cause, at least in part, an apparatus to perform all or part of the above methods.

According to another embodiment, an apparatus comprises means for performing all or part of the above methods.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of identifying a conversation in multiple short text strings, according to one embodiment;

FIG. 1B is a diagram of a data flow framework of the system of FIG. 1A, according to an embodiment;

FIG. 2A is a diagram of an example text string topic topology, according to an embodiment;

FIG. 2B is a diagram of a vocabulary and topic data structure, according to one embodiment;

FIG. 2C is a diagram of a user text string data structure, according to an embodiment;

FIG. 3A is a flowchart of a client process for identifying a conversation in multiple short text strings, according to one embodiment;

FIG. 3B is a flowchart of a step in the process of FIG. 3A, according to one embodiment;

FIGS. 4A-4D are diagrams of user interfaces utilized in the processes of FIG. 3, according to various embodiments;

FIG. 5 is a flowchart of a service process for identifying a conversation in multiple short text strings, according to one embodiment;

FIGS. 6A-6B are graphs comparing the conversations identified according to one embodiment with manually defined conversations, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program are disclosed for identifying a conversation in multiple strings. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term user refers to, for example, an entity that uses a service or device through a communications network, where an entity can be a person or an organization. A contact refers to, for example, a different user of the service with whom the user communicates through the service. As used herein, the term string refers to any data, and, in an illustrated embodiment, text string refers to a sequence of characters derived from any type of message sent between a device of the user and a device of the contact of the user over a communications network. Any message that has, for example, an associated time of sending or delivery or receipt may be used as a source of the text string, including emails and messages with character limits and no subject line metadata, such as SMS messages, IM messages and comments posted to a social network service, among others, or some combination. A text string derived from a source with a character limit can be called a short text string. A conversation refers to, for example, a collection of one or more text or other strings that are determined to be clustered in time and topic and associated with, for example, one contact of the user and any content associated with the collected text strings. Although various embodiments are described with respect to SMS messages exchanged at a mobile terminal, it is contemplated that the approach described herein may be used with other sources of text strings within any of one or more types of messages, alone or in any combination, exchanged at mobile terminals or fixed nodes on the communication network.

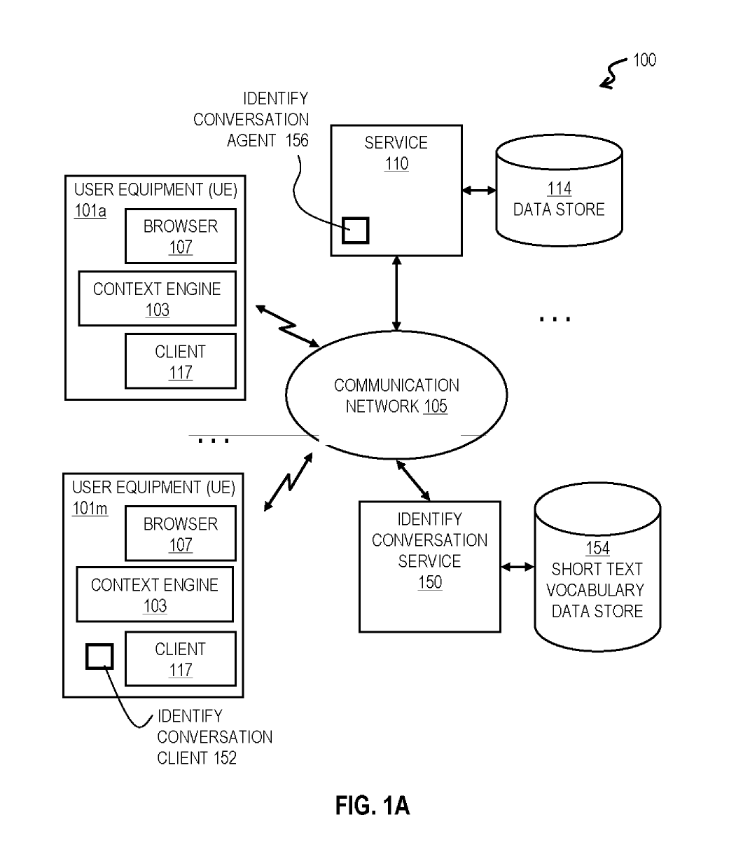

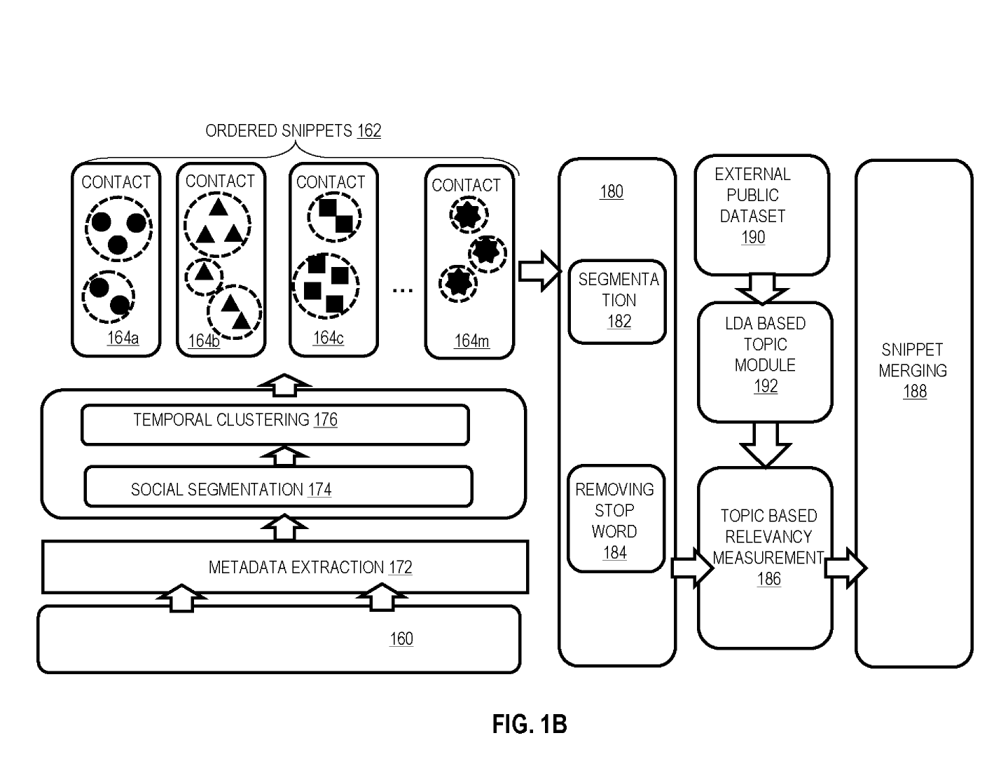

FIG. 1A is a diagram of a system 100 capable of identifying a conversation in multiple short text strings, according to one embodiment. A number M of users, called User A through User M for convenience, employ user equipment (UE) 101a through 101m, respectively, (collectively referenced hereinafter as UE 101) to each access network service 110, among other services indicated by ellipsis and collectively referenced hereinafter as network services 110. In some embodiments, the service 110 interacts with a service specific client process 117 on the UE 101. In some embodiments, the service 110 interacts with a more generic World Wide Web client process called a browser 107 on the UE 101. Each of the services 110 typically includes a service data store 114 to hold data related to the service, including data about each user of the service, called user profile data.

Some services 110 identify conversations based on temporal statistics or based on semantic content deduced from individual messages. While email provides a subject line and allows rather long messages that are capable of being mined for semantic content, short text strings used in IM, SMS and social networking comments provide neither subject lines nor sufficient text to support semantic analysis. In most cases, any piece of short message belongs to a specific conversation, but existing messaging tools cannot provide an efficient organization method to reveal such hidden conversations. Therefore, messages for such short text strings are not organized into conversations based on semantic content, and several different conversations might be jumbled together by the time statistics. Furthermore, a single conversation might mistakenly be represented as different conversations. Existing messaging management tools simply organize messages according to time, sender/receive or content. Detecting the thread of short texts in one conversation and organizing them as a conversation could help people be quickly reminded of the conversation scenario and grasp the core content. Therefore the prior organization of messages that include one or more messages with short text strings is deficient.

In order to provide an innovative messaging management tool which is suitable for IM, SMS and social community conversations, a mechanism and method is provided to automatically organize short texts to meaningful conversations based on their social/temporal attributes and the topic relevancy of contents. A system 100 of FIG. 1 introduces the capability to identify a conversation in multiple short text strings. An indentify conversation service 150 determines a semantic vocabulary and a topics model appropriate for short text string traffic or determines one or more parameters of a model to form conversations from short text strings based on temporal clustering and semantic similarity, or some combination. The vocabulary and topic model are stored in a short text vocabulary data store data structure 154. An identify conversation client process 152 monitors messages exchanged with one or more services 110 at the user equipment, e.g. at UE 101m, extracts text strings, including one or more short text strings, and organizes those test strings and any associated content into conversations based, at least in part, on the semantic vocabulary and topics model, the temporal clustering and the semantic similarity. The identify conversation client 152 also determines a label for the conversation, in some embodiments, and causes the conversation information to be presented with any label to a user of UE 101m, either by directly generating a user interface or through the service client 117 or through browser 107. In some embodiments, the service 110 includes an identify conversation agent 156 that is involved in interactions between the service 110 and identify conversation service 150, such as to obtain the identify conversation client 152 for installation in client 117.

Although shown as integral blocks in a particular arrangement of nodes connected to network 105 for purposes of illustration, in other embodiments, one or more processes or data structures or portions thereof are arranged in a different order. For example, some or all of the functionality of the client 152 is taken on by the service 150, e.g., in cloud computing arrangements.

As shown in FIG. 1A, the system 100 comprises user equipment (UE) 101 having connectivity to services 110 and identify conversation service 150 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.). In some embodiments, one or more of the UE 101 include context engines 103 that determine the current environment of the UE 101, such as a device identifier, installed equipment, current time, current connectivity to network 105 including signal strength and noise levels, power levels, and processes currently executing.

By way of example, the UE 101 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 4 and layer 7) as defined by the OSI Reference Model.

Processes executing on various devices, often communicate using the client-server model of network communications, widely known and used. According to the client-server model, a client process sends a message of one or more data packets including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host on which the process operates. Similarly, the term “client” is conventionally used to refer to the process that makes the request, or the host on which the process operates. As used herein, the terms “client” and “server” and “service” refer to the processes, rather than the hosts, unless otherwise clear from the context. In addition, the process performed by a server can be broken up to run as multiple processes on multiple hosts (sometimes called tiers) for reasons that include reliability, scalability, and redundancy, among others. A well known client process available on most devices (called nodes) connected to a communications network is a World Wide Web client (called a “web browser,” or simply “browser”) that interacts through messages formatted according to the hypertext transfer protocol (HTTP) with any of a large number of servers called World Wide Web (WWW) servers that provide web pages. As depicted in FIG. 1, the UEs 101 include browsers 107.

In an illustrated embodiment, short text strings are grouped into candidate conversations or conversation portions, called snippets hereinafter, through hierarchical clustering on time sequence. Secondly, snippets are merged into detected conversations, also called identified conversations, by incorporating semantic topic relevancy measures. Also, the most representative keywords of a topic which scores highest in the topic model are selected to make a label that provides a brief summarization of the core content of each conversation. These embodiments not only organize short text messages according to different contacts and time but also automatically detecting boundaries of adjacent conversations, such that, each detected conversation most likely coincides with an actual conversation.

FIG. 1B is a diagram of a data flow framework of the system of FIG. 1A, according to an embodiment. Main components of the framework include monitored text messages 160, metadata extraction module 172, social segmentation module 174, temporal clustering module 176, ordered candidate conversations called snippets 162, snippet text extraction module 180, topic based relevancy measurement module 186 and snippet merging module 188. The topic based relevancy measurement module 186 uses a topic module 192 based on Latent Dirichlet Allocation (LDA), which is based on an external public dataset 190 of text strings. The framework of FIG. 1B shows the combined functions of the identify conversations service 150 and client 152, with client 152 comprising components 160 to 188 and service 150 comprising components 190 and 192. It is contemplated that the functions of these components may be combined in one or more components or performed by other components of equivalent functionality.

The metadata extraction module 172 is responsible for extracting the sending/receiving time and sender/receiver's identifier (ID), e.g., a cell phone number or user name, from the text messages. The social segmentation module 174 divides all text message sets, from one or more services, into sub collections according to sender/receiver's ID, such that, each sub collection embraces all conversations related to a specific contact person. Temporal clustering module 176 automatically clusters time-sequence ordered text messages into snippets according to the temporal gaps between adjacent text messages with a single contact to produce snippets 162 ordered by contact 164a, 164b, 164c through 164m and time.

Snippet text extraction module 180 includes word segmentation module 182 and removing stop word module 184 to provide longer text strings for semantic analysis.

The external public dataset 190 is a large set of external test strings which cover topics of many aspects of daily life, such as collected from a twitter-like website, to generate a topic model which is applied to snippet texts for topic training. LDA based topic module 192 extracts topics which are frequently discussed in daily life from the external public dataset 190. Each topic is represented as a set of words from a vocabulary, followed by the probability indicating their occurrence in text directed to that topic. Topic based relevancy measurement module 186 aims to measure the semantic relevancy of adjacent candidate conversations called snippets herein. Snippet merging module 188 measures correlation between adjacent snippets by combing their temporal similarity and topic relevancy. Based on the value of the correlation, snippets can be merged to form automatically detected conversations.

In various embodiments, the semantics are determined based on a vocabulary and topics model stored in data structure 154 and may be constructed by LDA or any other method. For example, in various embodiments, probabilistic latent semantic indexing (pLSI) or Latent Dirichlet allocation (LDA), well known in the art, is used to deduce topics from words in a set of documents. Such methods can be used to derive short text string words and topics from a set of documents that are directed to the everyday circumstances of consumers of network services. Because each topic is associated with a group of words in certain relative abundances, there is a topology relating topics to words and subtopics to higher level topics.

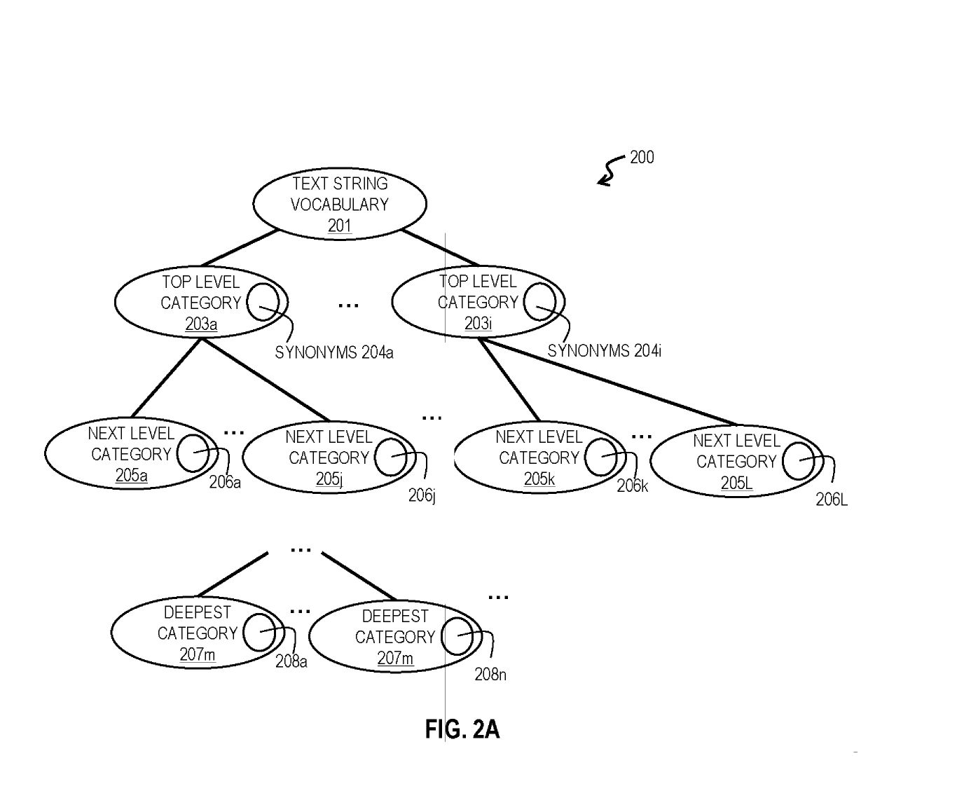

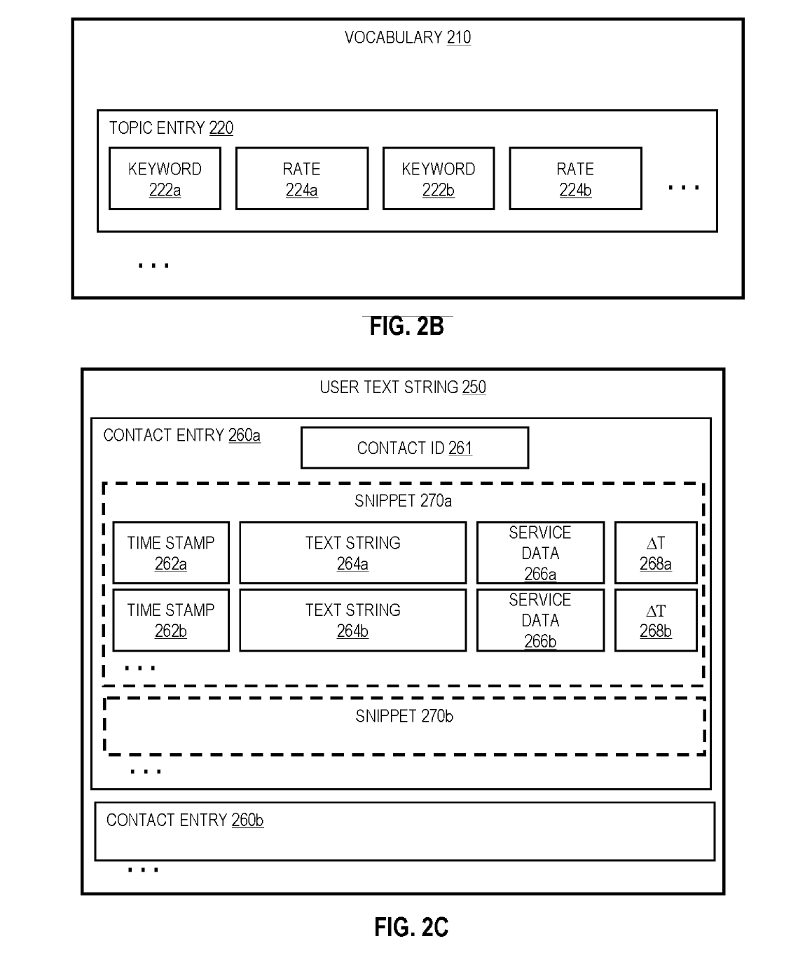

FIG. 2A is a diagram of an example text string topic topology 200, according to one embodiment. This text string topic topology is a hierarchical topology that is compared to the topics and words used in one or more text strings. At the top or root level is the text string vocabulary 201 as a whole derived from the public dataset of text strings assembled from many users. The text string vocabulary is different from other vocabularies, e.g., the vocabularies of biology or literature or language semantics constructed from different sets of training documents. Below the root level are the top level categories 203a to 203i, which are top level of text string topics, such as temporal text strings, spatial text strings, activity text strings, each encompassing one or more subtopics. Each topic is represented by a canonical name and zero or more synonyms, including the same name in different languages, such as synonyms 204a in top level category 203a and synonyms 204i in top level category 203i. One or more top level categories may be comprised of one or more next level categories 205a through 205j and 205k through 205L, each with their corresponding synonyms 206a, 206j, 206k and 206L, respectively. For example, temporal text string subcategories include time of day, day of week, day of month, month, and season. Intervening levels, if any, are indicated by ellipsis. At the deepest level represented by the deepest category 207a to 207m and corresponding synonyms 208a through 208m, respectively, are individual words or phrases such as Monday, o'clock, half past, quarter to, January, summer Individual words can appear in multiple higher level categories, e.g., Monday appears in week and non-weekend categories.

In some embodiments, e.g., in embodiments based on LDA, there are only two levels of categories, e.g., topics and words, below the root level text string vocabulary 201. Each topic is defined by a set of words, each with a particular range of occurrence percentages. In some of these embodiments, a vocabulary of V words is represented by a V-dimensional vector; and each word is represented by a V-dimensional vector with zeros in all positions but the position that corresponds to that particular word. Typically words of low meaning, such as articles, prepositions, pronouns and commonly used words are ignored, Each of Z topics is represented by a V-dimensional vector with relative occurrences of each word in the topic represented by a percentage in the corresponding word positions. All topics are represented by a V×Z matrix.

When a word from the text string vocabulary is found in a document, that word is considered a mixture of the different topics that include that word, with a percent probability assigned to each topic based on the percentage of words in the document, for example using the well known methods of LDA. As a result, the entire document can be represented by a set of topics found in the document with a probability metric assigned to each topic, e.g., a Z-dimensional vector with varying probabilities in each position of the vector. Such a vector is called a token herein. Two documents can be compared by computing a similarity of the two Z-dimensional vectors (tokens) representing those documents, such as a sum of products of corresponding terms. Alternatively, or in addition, a distance metric can be computed between the two documents, which increases as the two tokens become less similar. Any distance metric can be used, such as an order zero distance (absolute value of the coordinate with the largest difference), an order 1 distance (a sum of the absolute values of the Z differences,) an order two distance (a sum of the squares of the Z differences—equivalent to the Euclidean distance), an order three distance (a sum of cubes of absolute values), etc. The more similar are tokens from two documents, or the smaller the distance between those tokens, the more relevant are the documents to each other. In the following description, it is assumed that a text string vocabulary, e.g., as illustrated in FIG. 2, has been defined and is stored in a text string vocabulary data structure. The text string of a set of one or more messages is represented by a text string token. The more similar the text string tokens of sets of messages, e.g., the smaller the distance measure between them, the more relevant one set of messages is to the other set of messages.

In some embodiments the vocabulary data structure 154 is a Vx(Z+1) matrix, with the first V elements indicating each word in the vocabulary, also called a keyword; the next V elements indicating the probabilities of each keyword in the first topic; the next V elements indicating the probabilities in the next topic, etc.

In some embodiments, the dataset is first divided into a fixed number of manually chosen topics, e.g., 50 topics that include sports, politics, business, health, etc., and LDA is applied to determine the probabilities of keywords in each manually chosen topic. In some of these embodiments, the vocabulary is stored as shown in FIG. 2B. FIG. 2B is a diagram of a vocabulary and topic data structure 210, according to one embodiment. The vocabulary data structure 210 includes a topic entry field 220 for each topic, other topics indicated by ellipsis, collectively referenced hereinafter as topic entry fields 220. Each topic entry field 220 includes a first keyword field 222a, a first keyword rate of occurrence (or probability) field 224a, a second keyword field 222b, a second rate of occurrence field 224b, and other keyword and rate of occurrence fields indicated by ellipsis. The keyword fields 222a, 222b and other indicated by ellipsis are hereinafter referenced as keyword fields 222. Similarly, the rate of occurrence fields 224a, 224b and other indicated by ellipsis are hereinafter referenced as rate fields 224. In some embodiments, the keyword field 222 and associated rate field 224 are included in order from highest rate of occurrence to lowest rate of occurrence. In some embodiments an individual topic is identified by the order of the topic entry field 220 in the vocabulary data structure 210. In some embodiments an individual topic is identified by one or more keywords having the highest rates. In some embodiments the topic is identified by a manually provided name (e.g., sports) included in another field added into the topic entry field 220.

Although data structures and fields are depicted in FIG. 2A, and in FIG. 2B described next, as integral blocks in a particular arrangement for purposes of illustration, in other embodiments, the data structure or fields or portions thereof are arranged in a different order on one or more data structures or databases on one or more devices connected to the network 105, or one or more are omitted, or other fields are added, or the data structure is changed in some combination of ways.

In some embodiments, the text strings are stored as ordered snippets 162 in a user text string data structure 250 maintained by the identify conversation client 152. FIG. 2C is a diagram of a user text string data structure 250, according to an embodiment. The user text string data structure 250 includes a contact entry field 260a, 260b among others indicated by ellipsis (collectively referenced hereinafter as contact entry fields 260) for each contact of the user whose messages are being monitored. Each contact entry field 260 includes a contact identifier (ID) field 261 and a snippet field 270a, 270b among others indicated by ellipsis (collectively referenced hereinafter as snippet fields 270) for each snippet identified during processing.

Each snippet field 270 includes a time stamp field 262a, 262b among others indicated by ellipsis (collectively referenced hereinafter as time stamp fields 262) for each text string extracted from one message exchanged with the contact through one service 110. The time stamp field holds data that indicates when the corresponding text string was transmitted over the communication network as determined by the metadata extraction module 172. In some embodiments, the time stamp is corrected for differences between send time by UE 101a of another user, receipt time at service 110, send time at service 110, or receipt time at UE 101m. In some embodiments, one or more such time differences are ignored.

Each snippet field 270 includes a text string field 264a, 264b among others indicated by ellipsis (collectively referenced hereinafter as text string fields 264) for each text string extracted from one message exchanged with the contact through one service 110. The text string field 264 holds data that indicates the text extracted from the message.

Each snippet field 270 includes a service data field 266a, 266b among others indicated by ellipsis (collectively referenced hereinafter as service data fields 266) for each text string extracted from one message exchanged with the contact through one service 110. The service data field 266 holds data that indicates the service through which the message was transmitted. In some embodiments, the service data field 266 also indicates an identifier for the contact in the service, if different from the identifier indicated in field 261. In some embodiments, all text strings are associated with a single service; and service data field 266 is omitted.

Each snippet field 270 includes a ΔT field 268a, 268b among others indicated by ellipsis (collectively referenced hereinafter as ΔT fields 268) for each successive pair of text strings extracted from corresponding messages exchanged with the contact through one service 110. The ΔT field 264 holds data that indicates a time difference between the current time stamp field and the next, e.g., ΔT 268a indicates a time difference between times indicated in time stamp field 262a and time stamp field 262b. In various embodiments, the ΔT field 268 of the last message recorded in the contact entry field 260 is empty or the field 268 of the last message is omitted. In some embodiments, the time difference is determined as needed based on the times indicated in successive time stamp fields 262; and ΔT field 268 is omitted for every message.

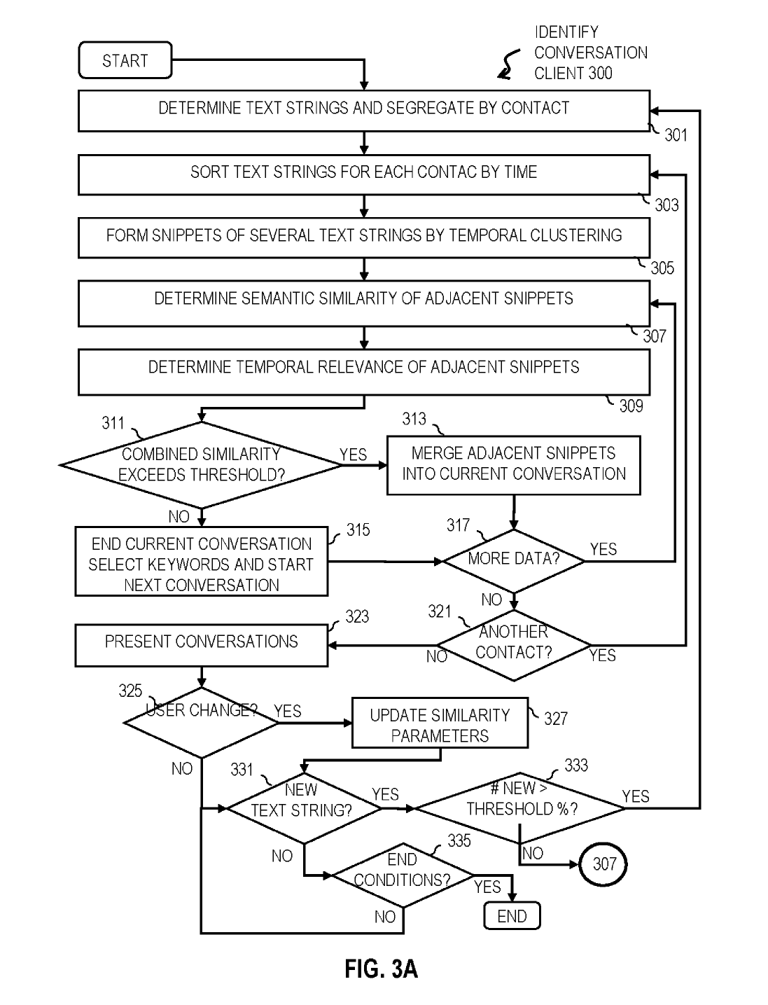

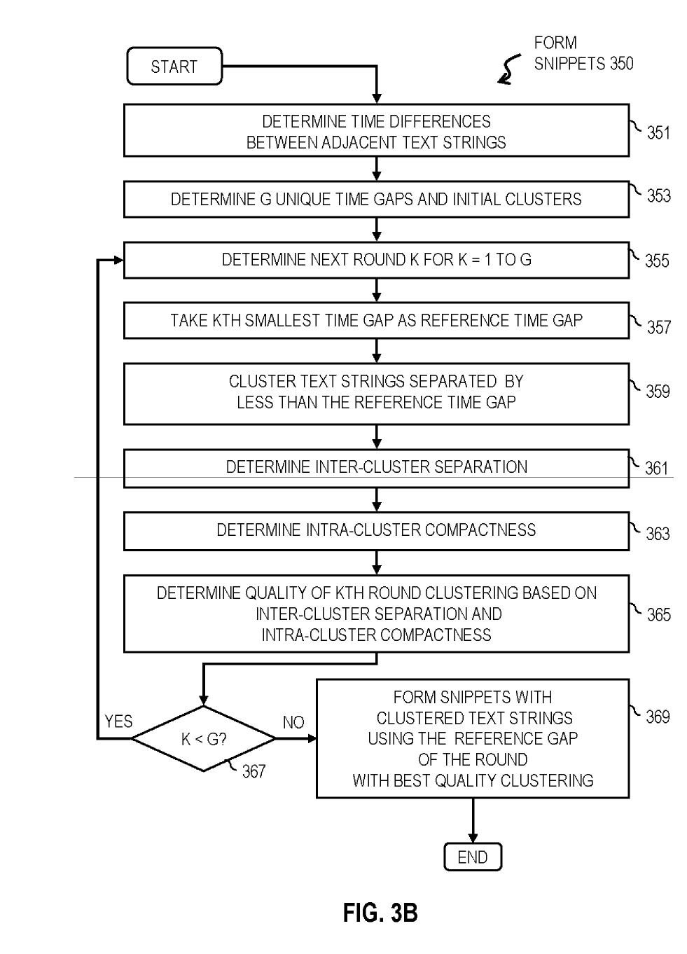

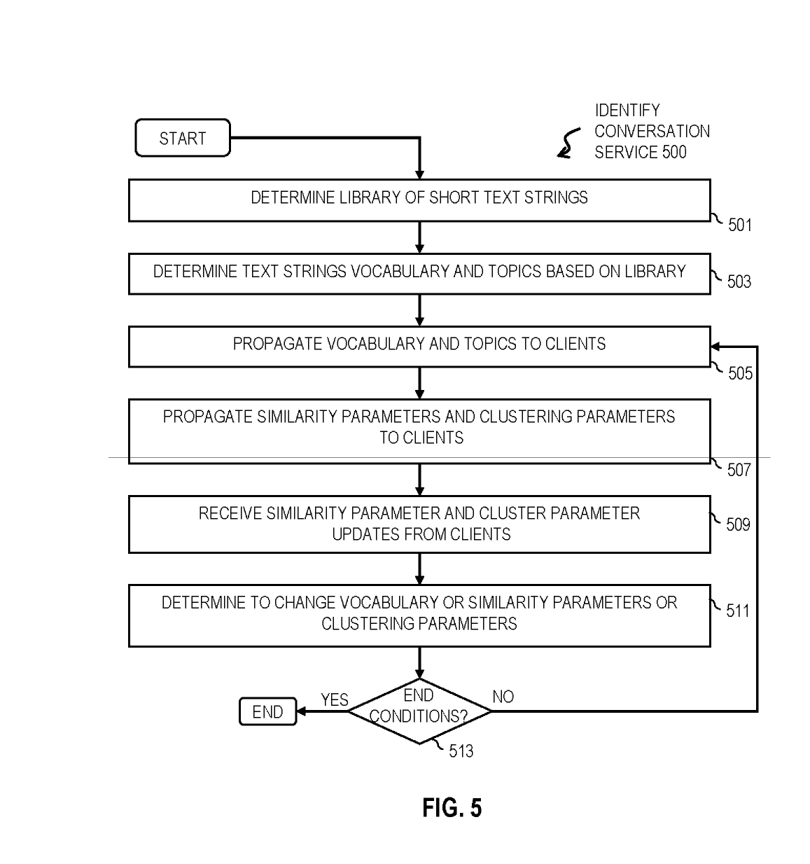

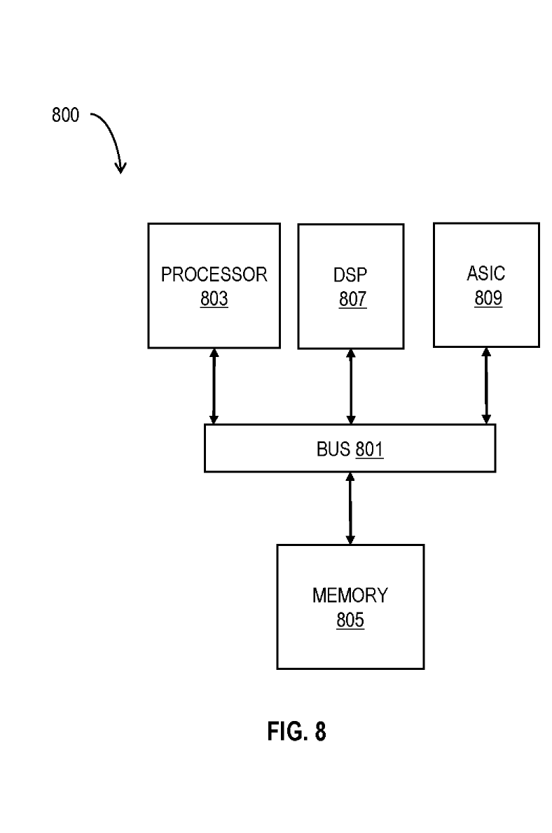

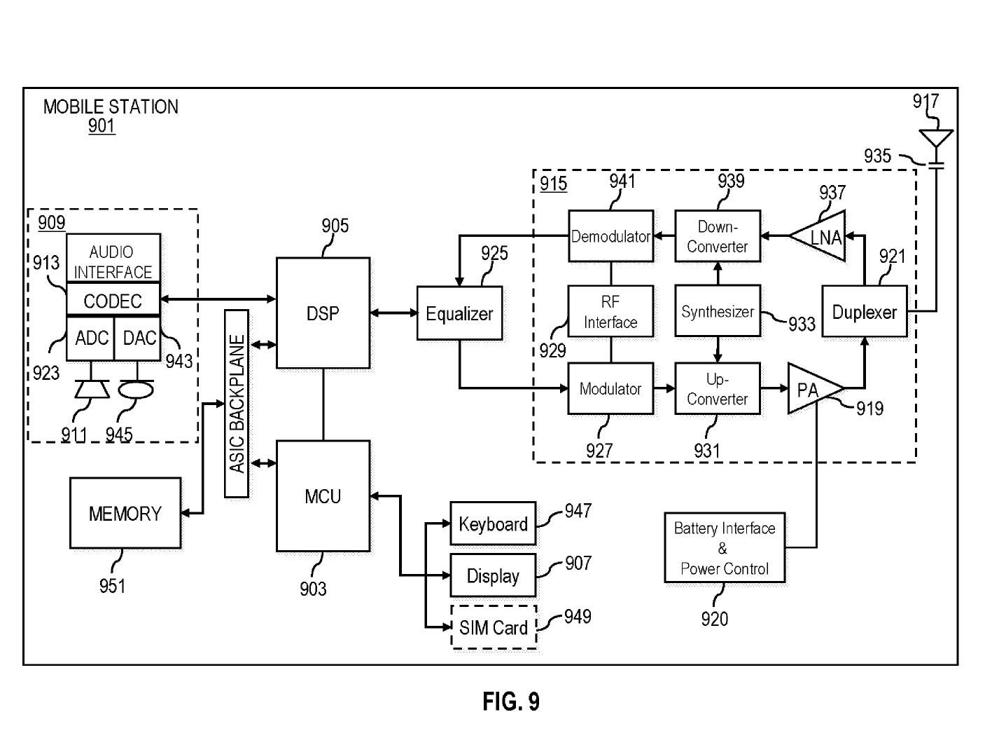

FIG. 3A is a flowchart of a client process 300 for identifying a conversation in multiple short text strings, according to one embodiment. In one embodiment, the identify conversation client 152 performs the process 300 and is implemented in, for instance, a chip set including a processor and a memory as shown in FIG. 8 or mobile terminal as presented in FIG. 9. Although steps are shown as integral blocks in a particular order in FIG. 3, and subsequent flowcharts in FIG. 3B and FIG. 5, in other embodiments, one or more steps or portions thereof are performed in a different order, or overlapping in time, in series or in parallel, or are omitted, or one or more other steps are added, or the process is changed in a combination of ways.

In step 301, text strings are determined and segregated by contact. Any method may be used to determine the text strings. For example, an identify conversation client 152 monitors message traffic between User M of UE 101m and users of other UE 101 through multiple services 110, e.g., long or short text strings from email messages, and short text strings from instant messaging messages, comments posted to one or more social network services or text in posts that the user has indicated a liking for, or metadata on photographs or other content associated with one or more contacts and posted to or downloaded from one or more services. Thus, in step 301, the text strings associated with the first contact text strings are derived from one or more instant messaging messages or one or more short message service messages or one or more metadata fields for content exchanged with the first contact, or some combination. For purposes of illustration, it is assumed that the identify conversation client module is within the client 117 of service 110 and only identifies conversations in messages exchanged through the service 110.

Step 301 includes segregating the text strings by contact in some embodiments. In some embodiments, step 301 includes determining multiple contact identifiers for the same contact, e.g., by querying User M for the identifier of User A on several services, e.g., querying for User A's email address, cell phone number, IM identifier and social network identifier. In some embodiments monitoring only messages within one service, step 301 includes segregating messages by the contact ID in that service 110 without prompting the user for any input. In some embodiments, all messages are considered regardless of contact; and segregating by contact is skipped.

In the illustrated embodiment, during step 301, the time stamp fields 262, text string fields 264 and service data fields 266 (if any) are filled for each contact entry field 260 in data structure 250, but not yet divided into snippets and not necessarily sorted in order of increasing time. In some embodiments, step 301 is performed by the metadata extraction module 172 and the social segmentation module 174. For example, during step 301, SMS messages are categorized into groups according to the metadata of sender/receiver's name or number. Each group contains all SMS messages which were exchanged with the specified contact. This embodiment ensures that conversations between different contacts do not overlap.

In step 303, text strings for each contact are sorted by time. For example, the fields in each contact entry field 260 are sorted in order of increasing value indicated by the data in the time stamp fields 262. In some embodiments, step 303 includes, after sorting by time, determining the time differences between times indicated by successive time stamp fields 262, e.g., between times indicated in time stamp field 262a and time stamp field 262b. The separation of entries by snippet is not yet performed.

For purposes of illustration, it is assumed that for the current contact there are N messages that have corresponding time stamps tn, for n=1, N. The set of time stamps is represented by the symbol T={tn, n=1, N}. The set of time differences, such as stored in ΔT fields 268, are represented as DT={DTn, n=1, N−1), where DTn represents the time difference between tn and t(n+1).

During step 305 the time ordered text strings are divided among one or more snippets, which are portions of a final detected conversation based on temporal statistics. In an illustrated embodiment, an un-supervised clustering algorithm is applied on the sorted SMS messages to work out all the potential snippets (candidate conversations) according to the time gaps between adjacent text strings. At the end of this flow path, statistical analysis is applied on the potential sets of snippets to select an optimized set of snippets, which approximate as close as possible to actual conversation portions. Step 305 is described in more detail below with reference to FIG. 3B. Thus step 305 includes determining from a first plurality of text strings associated with a first contact of a user, based on time separations between successive text strings, a first conversation portion (snippet) that comprises a plurality of text strings of the first plurality and a different second conversation portion (snippet) that comprises a different plurality of text strings of the first plurality.

FIG. 3B is a flowchart of a process 350 for step 305 in the process 300 of FIG. 3A, according to one embodiment. Thus process 350 is one embodiment of step 305. In step 351 the time differences DT between adjacent text strings are determined, as described above. In step 353 a number G of unique gap sizes are determined and sorted in order from smallest to largest gap size. The set of sorted unique gap sizes is represented by GS={GSg, g=1, G}, where GSg is the gth smallest gap size.

Initially, each text string is considered a separate potential snippet for a set of N potential snippets. The term cluster is used to refer to a set of time stamps of the text strings that are included in each potential snippet. Thus step 353 includes determining an initial set of clusters.

Steps 355 through 367 represent a loop of G rounds, computing the clusters based on different gap sizes and the associated quality measure.

After G rounds of hierarchical clustering, G+1 sets of clusters are produced, each set typically having fewer than N clusters, with the fewest clusters of all in the G+1st set of clusters. In step 369 the quality measures of the G+1 sets of clusters are evaluated to find the round that gives a set of clusters that is optimal by some objective measure. The clusters from that round determine the time stamps of text strings combined into the snippets (e.g., conversation portions) that are considered for merging based on semantic similarity.

In step 357, the kth smallest gap, GSk, is taken as a reference time gap for clustering time stamps.

In step 359 the time stamps of text strings that are separated by less than the reference time gap are joined in the same cluster. That is to say, the time gap between any adjacent text strings which belong to the same snippet is equal to or less than the reference time gap GSk, while the gap between adjacent time stamps of text strings on the boundaries of different snippets is larger than GSk.

For purposes of illustration, each round is indicated by the index k, where k=0, G; and k=0 indicates the initial clustering before the first round. The number of clusters on the kth round is given by Jk, each cluster during that round is represented by the symbol Cjk, where j=1, Jk, and the time stamps in the jth cluster on the kth round is given by the following expression,

Cjk={tq,q=pjk,pjk+Qjk−1} (1a)

where pjk is the first time stamp in the jth cluster on the kth round, and Qjk is the number of time stamps in the jth cluster on the kth round. The set of clusters in each round is represented by

ROUNDk=(Cjk,j=1,Jk} (1b)

Initially, k=0, J0=N and Qj0 is 1 for all N clusters, and thus

Cj0={tq,q=j,j}={tj} (2a)

and so

ROUND0=(Cj0,j=1,N} (2b)

Then, the clustering during step 359 results in satisfying the condition that within a cluster time differences are less than or equal to the reference gap, i.e.

t(q+1)−tq≦GSk, for pjk≦q<pjk+Qjk−1 for all j; (3a)

and between clusters time differences are greater than the reference gap, i.e.,

t(q+1)−tq>GSk, for q=pjk+Qjk−1 for all j. (3b)

Steps 361 to 365 determine an objective measure of quality of the clustering. From statistics, the optimal clustering corresponds to the best equalization point between an inter-cluster separation and intra-cluster compactness.

During step 361 an inter-cluster separation is determined; and during step 363 an intra-cluster compactness is determined. For example, inter-cluster separation is determined based on Equations 4; while an intra-cluster compactness is determined based on Equations 5.

$$\begin{matrix}Separation ( ROUNDk ) = {\sum }_{j = 1 , Jk} \vert mean ( Cjk ) - mean ( T ) \vert & ( 4 ) \\ Compact ( ROUND ) = {\sum }_{j = 1 , Jk} {\sum }_{q} \vert tq - mean ( Cjk ) \vert & ( 5 )\end{matrix}$$

where mean represents a function that determines an arithmetic mean of the time stamps in the following parentheses.

In step 365, a quality measure of the kth round is determined based on the inter-cluster separation and intra-cluster compactness. With an increase in the number of clusters, at lower values of k, the value of Separation in Equation 4 increases monotonically, while the value of Compact in Equation 5 decreases monotonically. Hence, an optimal balance point achieves the best clustering quality. Experiment shows that the sum of normalized Separation (e.g., Sep in Equation 6b) and exponential transformation of normalized Compact (e.g., Scat in Equation 6c) results in best species recognition accuracies. Therefore, a utility or quality function Q is defined for each round by Equation 6a through 6d.

MAX=Compact(ROUNDG)=Separation(ROUND0) (6a)

Sep(ROUNDk)=Separation(ROUNDk)/MAX (6b)

Scat(ROUNDk)=[Compact(ROUNDk)/MAX]^{α} (6c)

Q(ROUNDk)=Scat(ROUNDk)+Sep(ROUNDk) (6d)

A value of the parameter α in Equation 6c is determined by experiment.

In step 367 it is determined whether all gap sizes have been tried, e.g., whether k=G. If not, e.g., if k<G, then control passes back to step 355 to determine the clustering in the next round using the next gap size as a reference. If all gap sizes have been tried, then, in step 369 snippets are formed using the clustering that gives the best value of the quality function Q. Step 369 includes sorting the quality of clustering value of function Q among the G+1 rounds of clustering and select the minimum one to represent the snippets. For purposes of illustration, it is assumed that round B corresponds to the best round, because it satisfies Equation 7.

ROUNDB=arg min_{k=0,G}[Q(ROUNDk)] (7)

Step 369 ends step 305 in FIG. 3A. Thus, each text string has been grouped into an appropriate snippet, e.g., candidate conversation portion, of one or more text strings. This information is stored in user text strings data structure 250 as indicated by the snippet fields 270, e.g., as the first and last time stamps of the text strings in each snippet.

However, a conversation lasting for a long time span may be separated into several snippets based only on temporal clustering. It was recognized that, if two candidate conversations belong to the same conversation, they should focus on the same topic. Advantageously, as the short text strings have been grouped in snippets as a result of the temporal clustering, a snippet is much richer in text than each individual text string, especially richer than an individual short text string. Thus semantic analysis is more effectively applied on the combined text of these text strings grouped in each snippet. Based on this consideration, the results of temporal clustering are revised by incorporating semantic analysis based on a topic model.

In step 307, the semantic similarity of adjacent snippets is determined. Step 307 includes extracting the text string from each text message. Then, the extracted texts are put together to form a snippet for each temporal cluster. Then, basic natural language processing (NLP) technologies of word segmentation and stop words removal are applied on each snippet. A topic model based on the large external data set is applied. Formation of the topic model is described in more detail below with reference to the identify conversation service 150 process in FIG. 5. Thus, step 307 includes determining a semantic vocabulary and topics based on a library of text strings. For purposes of illustration, it is assumed that the topic model includes Z topics, represented by Yz, z=1, Z. Recall that Yz is a vector of rates of occurrence for each of up to V keywords. Thus step 307 includes determining a first semantic content for the first conversation portion (snippet) and a second semantic content for the second conversation portion (snippet).

In an example embodiment, during step 307, the snippets obtained from temporal clustering are compared to the topics of the topic model to form a vector of topic relevancies. Recall that the number of clusters on the kth round is given by Jk, and that round B provided the highest quality clustering, thus there are JB snippets for the current contact, represented by the symbol dj, j=1, JB. The relevance of the zth topic, z=1, Z for the jth snippet, dj, is given by rjz and is the sum of probability Prob of the words which occur in snippet dj and topic Yz simultaneously, as defined in Equation 8.

rjz=ΣProb(word) (8)
word εYz∩dj
   The semantic meaning of snippet dj is given by a vector Rj={rjz, z=1, Z} which is a point in Z dimensional space. The value in each dimension reflects its relevancy with the corresponding topic. Thus, step 307 includes determining the first semantic content and the second semantic content based, at least in part, on the semantic vocabulary and topics.

Step 307 includes determining the semantic relevancy between adjacent snippets. For the two adjacent snippets dj and d(j+1), we define their topic relevancy by Equation 9a

RELj,(j+1)=max(min(rjz,r(j+1)z,z=1,Z) (9a)

Where min is a function that yields the minimum value of a list of values in the following parentheses, and max is a function that yields the maximum value of a list of values in the following parentheses. The underlying concept for the relevancy measurement is based on the consideration that the relevancy between two snippets under a certain topic is determined by the less irrelevant one and the global relevancy is reflected by the maximum of the 50 dimensions. Then, a topic relevancy vector is determined for all the JB snippets of the current contact, given by Equation 9b.

RELEVANCY=[REL(j−1),j,j=1,JB]^{T} (9b)

where the superscript T represents a vector transpose operation.

In step 309, the temporal relevance of adjacent snippets is determined. For example, the temporal distance between two adjacent candidate conversations are taken into account. Recall that the number of text strings in the jth snippet of the kth round is given by Qjk and that there are Jk snippets in round k and that the best clustering was obtained for round B. Thus after temporal clustering there are JB snippets, with QjB text strings in the jth snippet. The time stamps in each snippet are given by Equation 1a, with k=B. The temporal correlation, designated TEMPORAL, between two adjacent snippets is computed using Equation 10a.

TEMPORALj,(j+1)=exp [−|tp(j+1)B−t(pjB+QjB−1)|/P], for 1≦j<JB (10a)

where the last time stamp of the jth snippet t(pjB+QjB−1) is subtracted from the first time stamp of the j+1 snippet tp(j+1); and the parameter P is determined by experiment. In an illustrated embodiment, P is 10000 seconds. The temporal correlation vector for all the snippets of the current contact, TEMPORAL, is constructed as given by Equation 10b.

TEMPORAL=[TEMPORALj,(j+1),j=1,JB−1] (10b)

In some embodiments, step 309 is omitted, and only semantic relevance is considered in merging adjacent snippets.

In step 311, it is determined whether a combined measure of relevancy exceeds a threshold. For example, both topic relevancy, REL, and temporal similarity, TEMPORAL, are combined together to measure the correlation between two adjacent snippets. A parameter CORRELATION is determined according to Equation 11.

CORRELATIONj,(j+1)=TEMPORALj,(j+1)×RELj,(j+1) for 1≦j<JB (11)

Then the hierarchical clustering algorithm described in FIG. 3B is used with the CORRELATIONj,(j+1) values representing the distance between the j and j+1 snippet to determine whether to merge snippets into a detected conversation. Thus, the threshold is dynamically determined. In some embodiments, a predetermined threshold based on experiment is used; and snippets closer than the predetermined threshold are merged. Thus, step 311 includes determining whether to merge the first conversation portion (snippet) and the second conversation portion (snippet) into a first conversation that includes the first conversation portion based, at least in part, on a similarity of the first semantic content to the second semantic content.

In step 313, it is determined to merge adjacent snippets into the current conversation if the combined similarity does exceed the dynamic or predetermined threshold. Thus, in step 313, determining whether to merge the first conversation portion and the second conversation portion further comprises combining the first conversation portion and the second conversation portion into the first conversation, if the similarity is determined to exceed a similarity threshold.

In step 315, it is determined to start a new conversation if the combined similarity does not exceed the dynamic or predetermined threshold. Thus, in step 315, determining whether to merge the first conversation portion and the second conversation portion further comprises putting the second conversation portion into a different second conversation, if the similarity is determined not to exceed a similarity threshold.

In step 317, it is determined if there is more data for the same contact. If so, control passes back to step 307 described above. In some embodiments, that do not use a predetermined threshold, step 317 is omitted.

In step 321, it is determined if there is another contact for which conversations are to be identified. If so, then control passes back to step 303, described above. In some embodiments, messages for all contacts are merged together and step 321 is omitted.

In step 323 the detected conversations are presented to the user, e.g., User M of UE 101m through a display on UE 101m, as prepared directly by the client 152 or through the client 117 or through the browser 107. In some embodiments, step 323 includes determining a label for each conversation based on keywords of one or more topics that have high relevance for one or more or most snippets included in the detected conversation.

Within each detected conversation, the key words of the topic are extracted. In some embodiments, the most relevant topic for a conversation w is selected from the trained topic model. Suppose topic Yx is the most relevant topic for the detected conversation w. Yx should satisfy the condition that x=arg max rwz, z=1, Z. After that, the words common to both the detected conversation w and topic Yx with highest probability in the topic is selected as the key words of the detected conversation w.

Thus, step 323 includes determining a first conversation label for the first conversation based, at least in part, on a semantic topic for the first semantic content. Step 323 also includes presenting data that indicates the first conversation label.

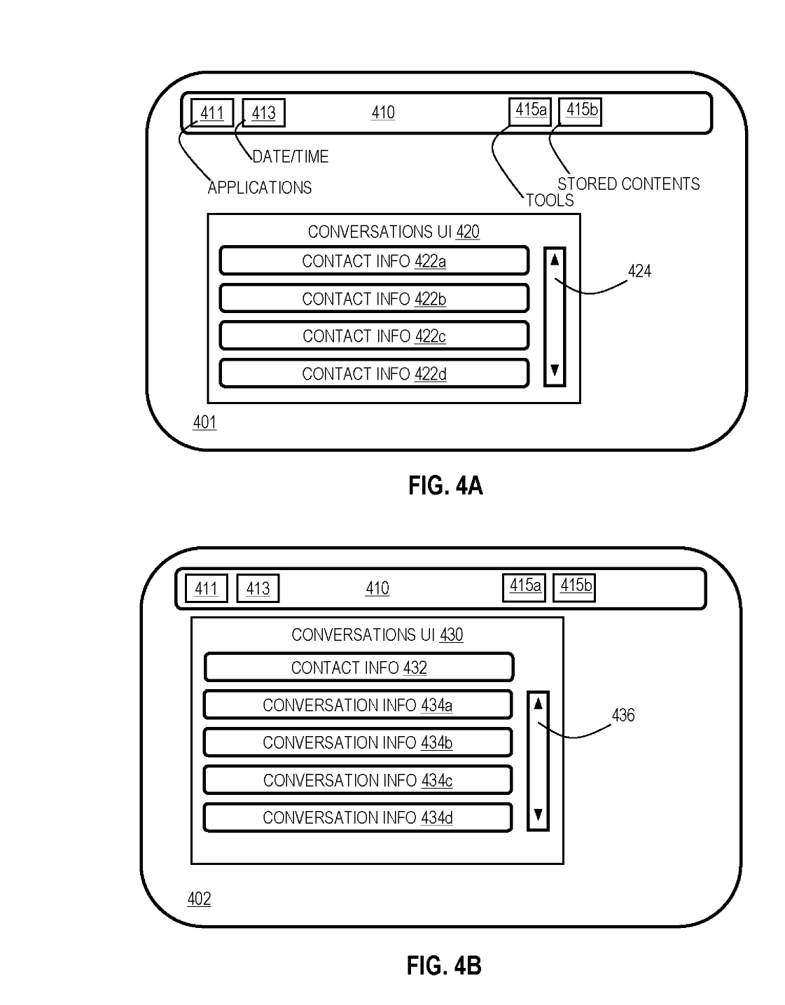

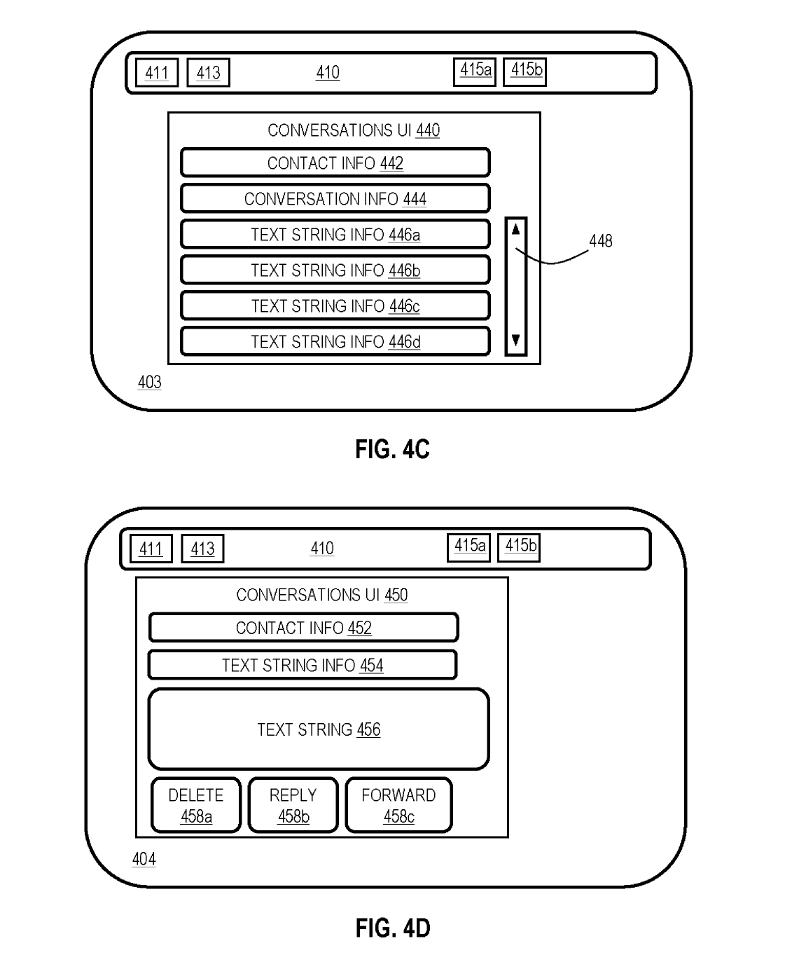

FIGS. 4A-4D are diagrams of user interfaces utilized in the processes of FIG. 3, according to various embodiments. FIG. 4A is a diagram that illustrates an example screen 401 presented at UE 101. The screen 401 includes a device toolbar 410 portion of a display, which includes zero or more active areas. As is well known, an active area is a portion of a display to which a user can point using a pointing device (such as a cursor and cursor movement device, or a touch screen) to cause an action to be initiated by the device that includes the display. Well known forms of active areas are stand alone buttons, radio buttons, pull down menus, scrolling lists, and text boxes, among others. Although areas, active areas, windows and tool bars are depicted in FIG. 4A through FIG. 4D as integral blocks in a particular arrangement on particular screens for purposes of illustration, in other embodiments, one or more screens, windows or active areas, or portions thereof, are arranged in a different order, are of different types, or one or more are omitted, or additional areas are included or the user interfaces are changed in some combination of ways.

For purposes of illustration, it is assumed that the device toolbar 410 includes active areas 411, 413, 415a and 415b. The active area 411 is activated by a user to display applications installed on the UE 101 which can be launched to begin executing, such as an email application or a video player or the identify conversation client application. The active area 413 is activated by a user to display current context of the UE 101, such as current date and time and location and signal strength. In some embodiments, the active area 413 is a thumbnail that depicts the current time, or signal strength for a mobile terminal, or both, that expands when activated. The active area 415a is activated by a user to display tools built-in to the UE, such as camera, alarm clock, automatic dialer, contact list, GPS, and web browser. The active area 415b is activated by a user to display contents stored on the UE, such as pictures, videos, music, voice memos, etc.

The screen 401 also includes a conversations user interface (UI) area 420 in which the data displayed is controlled by the identify conversation client 152, either directly or through client 117 or a browser 107. According to some embodiments, the conversation UI area 420 includes multiple contact information areas 422a, 4222b, 422c, 422d, among others, collectively referenced hereinafter as contact info areas 422. A scrollbar 424 is included to move contacts not currently in view in conversations UI 420, if any, into view within area 420.

Each contact info area 422 presents information that indicates the contact identifier (ID) for one contact of the user, an icon or avatar of the contact, if any, a service through which text messages are exchanged, if more than one service is monitored by the identify conversation client 152, and a number of conversations identified with that contact. In other embodiments more or different items are included in each contact info area 422. Thus, conversation UI 420 comprises presenting data that indicates a number of conversations determined for each of a plurality of contacts of the user.

If the user activates a contact info area 422, a modified conversations UI area 430 is presented, as illustrated in FIG. 4B. FIG. 4B is a diagram that illustrates an example screen 402 presented at UE 101. In the illustrated embodiment, the conversations UI area 430 includes a contact info area 432, and one or more conversation information active areas 434a, 434b, 434c, 434d, collectively referenced hereinafter as conversation info areas 434. A scrollbar 436 is included to move conversation info areas 434 not currently in view in conversations UI 430, if any, into view within area 430.

Each conversation info area 434 presents information that indicates the contact identifier (ID) for one contact of the user, a start time and end time of the conversation, and one or more keywords that label the conversation, as determined during step 315 and described above. In other embodiments more or different items are included in each conversation info area 434. Thus, conversation UI 430 comprises presenting data that indicates each conversation of the plurality of conversations with a first contact.

If the user activates a conversation info area 434, a modified conversations UI area 440 is presented, as illustrated in FIG. 4C. FIG. 4C is a diagram that illustrates an example screen 403 presented at UE 101. In the illustrated embodiment, the conversations UI area 440 includes a contact info area 442, a conversation info area 444 and one or more text string information active areas 446a, 446b, 446c, 446d, collectively referenced hereinafter as text string info areas 446. A scrollbar 448 is included to move text string info areas 446 not currently in view in conversations UI 440, if any, into view within area 430. As in conversation info areas 434 depicted in FIG. 4B, the keywords extracted from the conversation during step 315 can be shown in conversation info area 444.

Each text string info area 446 presents information that indicates the contact identifier (ID) for one contact of the user, a time stamp for the text string, and the text string extracted from one message monitored by the identify conversation client 152. In some embodiments, incoming messages are in one color and outgoing messages are in a different color. In other embodiments more or different items are included in each text string area 434. For example, in some embodiments, content associated with the text string, such as an audio file or image is also presented in the text string info. In some embodiments, advertisements related to the keyword in the label in the conversation info area 444 are also presented in conversations UI area 440.

In some embodiments a user can change the text strings in a conversation e.g., by activating a DELETE or MOVE active area in each text string info area 446.

If the user activates a text string info area 4464, a modified conversations UI area 450 is presented, as illustrated in FIG. 4D. FIG. 4D is a diagram that illustrates an example screen 404 presented at UE 101. In the illustrated embodiment, the conversations UI area 450 includes a contact info area 452, a text string info area 454, a text string area 456 and one or more buttons 458a, 458b, 458c, collectively referenced hereinafter as buttons 458.

Each text string area 456 the full text and any associated content of one message exchanged with a contact. For example, in some embodiments, content associated with the text string, such as an audio file or image is also presented in the text string area 456. In some embodiments, advertisements related to the keyword in the text string are also presented in conversations UI area 450. In some embodiments, a scrollbar is include in text string area 456 to move text or content not currently in view in area 456, if any, into view within area 456.

The buttons 458, include a delete button 458a, a reply button 458b and a forward button 458c to respectively delete the message, reply to the message or forward the message to a another user, as is common on message interfaces for one or more services 110.

Thus in conversation UI 440, step 323 also includes presenting data that indicates the first conversation portion (snippet) in association with the first conversation label

In step 325, it is determined whether the user has changed a conversation, e.g., by splitting one detected conversation into two or more separate conversations, or by merging separate detected conversations into a single conversation. If not, control passes to step 331, described below. If so, then in step 327 the change is used to determine if one or more parameters, such as a or P or any predefined thresholds should be changed to better match the user-indicated results. If such changes are determined in step 327 they are propagated to the identify conversation service 150 to propagate to other clients 152 on other UE 101, or to clients 152 directly.

In step 331, it is determined whether a new text string is received, e.g., in a new SMS message. If not, then control passes to step 335 to determine if end conditions are satisfied. If a new text string is received, then in step 333 it is determined if the proportion of newly arrived text strings in the whole corpus exceeds a certain threshold. If so, then control passes back to step 301, described above to start a new round of processing for the whole set of text messages. If not, then control passes back to step 307 to add the new test string to an existing conversation or to start a new conversation based on semantic relevance or temporal relevance or both. No new hierarchical clustering is done, in some embodiments, but, instead, thresholds already determined in earlier semantic and temporal analyses are used as predetermined thresholds.

In some embodiments, step 331 includes a different process for text strings extracted from incoming messages than for text strings extracted from outgoing messages. For example, in some embodiments, every new arriving SMS message is assigned to a conversation in real time, to avoid applying the above mentioned clustering algorithms every time a new message arrives, since it is not time efficient. Therefore, an incremental clustering mode is adopted for the new SMS messages. Trading off the runtime performance and the clustering accuracy, the following steps are taken. The newly arriving SMS message is merged with its closest conversation if the temporal gap between the newly arrived SMS message and the last SMS message is less than the optimal gap which was selected in the last temporal clustering. Otherwise, a new conversation is started. If the proportion of the newly arrived SMS messages in the whole corpus exceeds a certain threshold, then a new temporal clustering is started; and, the snippet correlation vector is re-calculated. For outgoing messages, it is assumed that a new message belongs to a new conversation, and that a replying message belongs to the same conversation with the one it replies. In some embodiments, to detect when a user starts a new conversation by replying to a message purely for convenience, the time correlation threshold is also checked, and if exceeded, a new conversations started anyway.

In step 335, it is determined if end conditions are satisfied, such as closing down the application. If so the process ends, otherwise control passes back to step 331 to await the next message with a text string.

FIG. 5 is a flowchart of a service process 500 for identifying a conversation in multiple short text strings, according to one embodiment.

In step 501, a library of short text string messages is received to use as a public dataset to define vocabularies and topics. For example, TWITTER™ is now becoming a popular web tool to realize information sharing and diffusion. The contents have covered various public topics about aspects of ordinary daily life. Additionally, text strings are usually short, so they have similar properties with SMS messages and other short messages described herein. Based on these considerations, external public data was collected from twitter for training the topic model. On the application server side, a web crawler module is responsible for crawling web pages containing designated keywords from the twitter web site and assembling them in documents on which a topics model can be applied.

In step 503, text string vocabulary and topics are determined based on the library. For example, LDA is run to determine keywords and topics automatically. In some embodiments, a manual operation is included. For example, topics are selected from one or more public websites, and text associated with those topics are collected. LDA is used to find the keywords and probabilities for each topic.

In step 505 the vocabulary and topics are propagated to one or more identify conversation clients 152, e.g., through the actions of one or more identify conversation agents 156. These keywords and topics are stored locally in one or more vocabulary data structures 210 based on messages that include similar fields.

In step 507, similarity parameters and clustering parameters are propagated to clients. For example, scripts for the identify conversation client 152 is sent to one or more UE 101, directly or through the agent 156 on a service 110. In some embodiments, values for the parameters α and P or one or more predetermined thresholds are propagated during step 507.

In step 509, one or more updates for similarity parameters, such as values for the parameters α and P or one or more predetermined thresholds, are received from one or more identify conversation clients 152 based on user input changing one or more detected conversations or topic labels for those conversations.

In step 511, it is determined to change the vocabulary or topics or similarity parameters of clustering parameters based on the updates received during step 509. If so, the new values are included to be propagated during the next execution of step 505.

In step 513, it is determined if end conditions are satisfied, for example that the service is shutting or the vocabulary is complete. If so, the process ends, otherwise the process continues back at step 505 to propagate parameters with any updates, as described above.

Test embodiments have been produced. A real dataset collected from 50 university student volunteers during 6 months includes over 122,300 text messages, assigned to meaningful conversations by their owners. This is used as ground truth for experiments. The experiments are divided into 3 phases. Firstly, 5 datasets from 5 different volunteers were selected as training datasets to tune the parameter of a in Equation (6c), and select the most appropriate one by comparing the F-score, defined below. Secondly, 1 dataset from another volunteer was selected as the testing dataset to evaluate the quality of temporal clustering. In the third phase, the semantic relevancy of each snippet based on the temporal clustering was determined using different approaches, namely a traditional TF-IDF approach, a short text topic relevancy algorithm proposed by X Quan, and the illustrated embodiment. After that, the snippets were merged into detected conversations based on hierarchical clustering on the CORRELATIONj,(j+1) values. A final comparison is made on the results obtained from the different approaches of semantic relevancy computing.

Precision, recall and F-score were adopted as the most important indicators to evaluate the effectiveness of each approach. These are defined as follows.

$$\{ \begin{matrix}precision = \frac{correctly detected conversations}{totoal number of detected conversations} \\ recall = \frac{correctly detected conversations}{totoal number of ground truth conversations} \\ F \text{-} score = \frac{2 \times precision \times recall}{precision + recall}\end{matrix}$$

Table 1 lists the training datasets that were used to learn a preferred value for α.

| Volunteer/ | |
|---|---|
| Contact | Number of |
| Person | Messages |
| A/A1 | 523 |
| B/B3 | 576 |
| C/C6 | 475 |
| D/D4 | 492 |
| E/E8 | 506 |

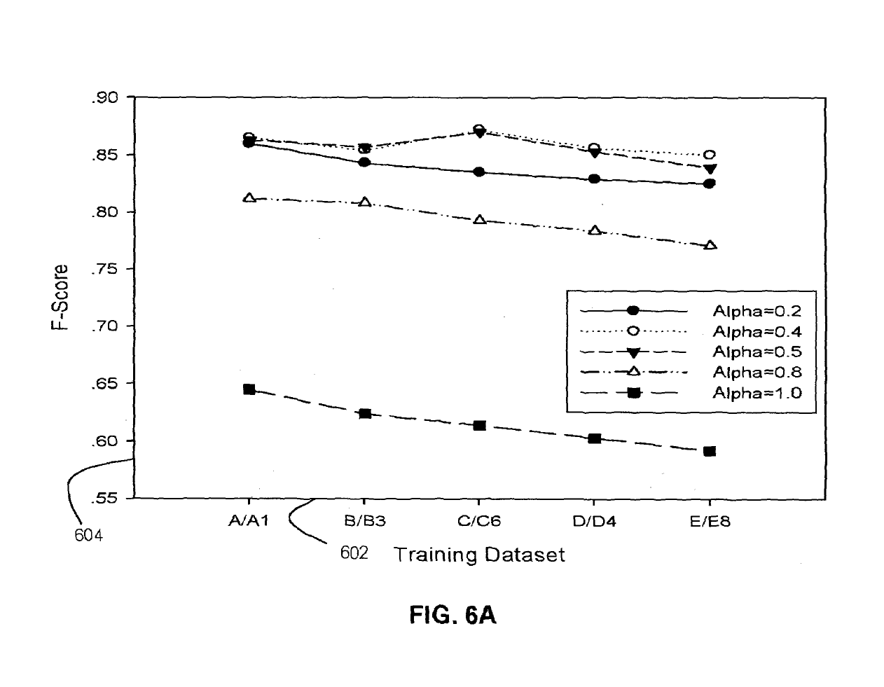

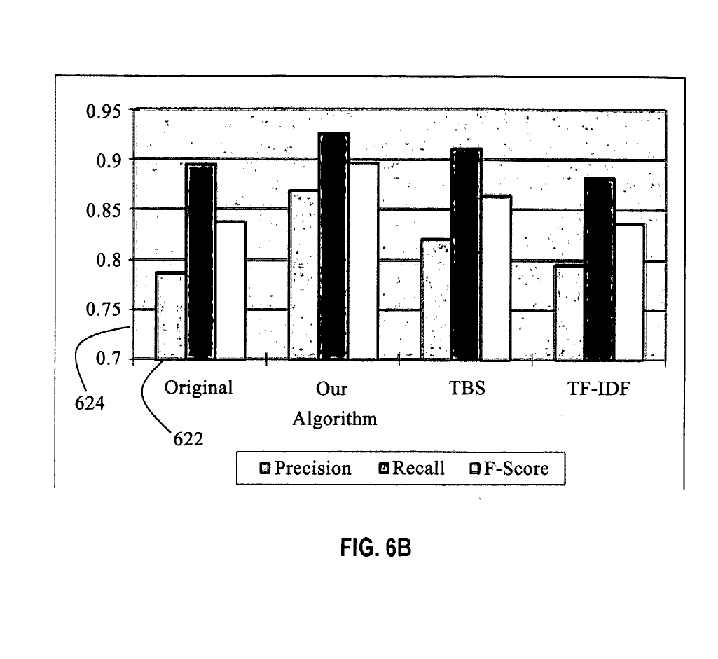

FIGS. 6A-6B are graphs comparing the conversations identified according to one embodiment with manually defined conversations, according to one embodiment. FIG. 6A is a graph of the F-score as a function of a choice for the parameter α in the five datasets of Table 1. The horizontal axis 602 is training dataset, the vertical axis 604 is F-score, which is dimensionless. As shown in FIG. 6A, the best result is obtained for α of about 0.4. This value of α is used in the following experiments.

In the next experiment, hierarchical temporal clustering was applied to a testing dataset to determine the gap that gives the best value of quality function Q. The results are given in Table 2.

TABLE 2
Results of temporal clustering

| | Actual | Detected | Reference gap |
|---|---|---|---|
| Messages | conversations | snippets | (hours) |
| 1001 | 202 | 230 | 0.9034 |

As shown in Table 2, 230 candidate conversations are detected from 1001 text messages. The actual number of conversations is 202. If the temporal distance between any adjacent text messages is no greater than 0.9034 hour, they are grouped in a same snippet. The reason why the number of detected snippets is larger than the number of actual conversation is that, in certain situations, people return back to an unclosed conversation after a long period time that is larger than the detected optimal reference temporal distance of 0.9034 hour. Some such returns are expected to be captured by merging snippets based on semantic relevance.

In the next experiments, merging of snippets was attempted through three approaches of semantic relevancy computing algorithms: TF-IDF, TBS, and our approach. TF-IDF is a traditional text similarity computing algorithm; and TBS is proposed by Xiaojun Quan in 2009. They also exploited LDA model to compare the similarity between two text messages. Different from the illustrated embodiments, they first represent a text message as a vector, and use TF-IDF to compute the weight of each element of the vector, and then they select out the different words between two snippets and modify the values with their counterpart's probability related to a specified topic. At last, the similarity is calculated by computing the cosine value of the two modified vectors.

In the experimental embodiment presented here, the topic relevancy between adjacent snippets is calculated with the 3 algorithms individually. And then the correlation between each adjacent snippet is calculated by multiply corresponding topic relevancy and temporal distance, as described above with reference to Equation 11. After that, hierarchical clustering was applied to group the snippets into detected conversations for all three algorithms. In this experiment, precision, recall and F-Score are determined to measure the performance of the three approaches. The baseline is also the ground truth manually labeled by the volunteer themselves. After the experiment, it was noted that the precision and recall are both improved after combining the text content analysis with TBS and our algorithm, but it remains unchanged or even falls a little with TF-IDF approach. This is believed to be because TF-IDF measures the similarity merely based on word co-occurrence. In contrast, there are relative few common words in different snippets, and even when they share common words, they may belong to different conversations. FIG. 6B illustrates the changes of precision, recall and F-Score. The horizontal axis 622 indicates approach taken, and the vertical axis 624 indicates score. For each approach, the left bar is precision score, the middle bar is recall score and the right bar is F-Score.

The processes described herein for identifying a conversation in multiple short text strings may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

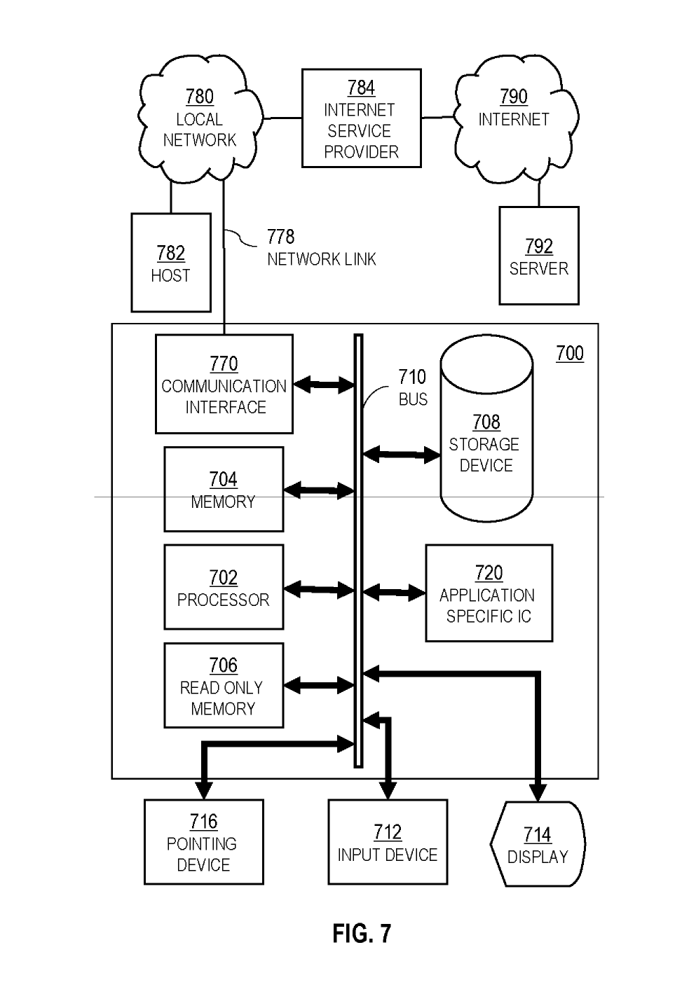

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to identify a conversation in multiple short text strings as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of identifying a conversation in multiple short text strings.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to identifying a conversation in multiple short text strings. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for identifying a conversation in multiple short text strings. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for identifying a conversation in multiple short text strings, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for identifying a conversation in multiple short text strings at the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to identify a conversation in multiple short text strings as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of identifying a conversation in multiple short text strings.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to identify a conversation in multiple short text strings. The memory 805 also stores the data associated with or generated by the execution of the inventive steps.

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of identifying a conversation in multiple short text strings. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of identifying a conversation in multiple short text strings. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to identify a conversation in multiple short text strings. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-28. (canceled)

29. A method comprising:
determining from a first plurality of strings associated at least in part with a first contact of a user, based at least in part on time separations between successive strings, a first conversation portion that comprises a plurality of strings of the first plurality and a different second conversation portion that comprises a different plurality of strings of the first plurality;
determining a first semantic content for the first conversation portion and a second semantic content for the second conversation portion; and
determining whether to merge the first conversation portion and the second conversation portion into a first conversation that includes the first conversation portion based, at least in part, on a similarity of the first semantic content to the second semantic content.

30. A method of claim 29, wherein determining whether to merge the first conversation portion and the second conversation portion further comprises combining the first conversation portion and the second conversation portion into the first conversation, if the similarity is determined to exceed a similarity threshold.

31. A method of claim 29, further comprising determining a first conversation label for the first conversation based, at least in part, on a semantic topic for the first semantic content.

32. A method of claim 29, wherein the strings associated at least in part with the first contact are derived from one or more instant messaging messages or one or more short message service messages or one or more metadata fields for content exchanged with the first contact, or some combination.

33. A method of claim 29, wherein:
the first contact is one of a plurality of contacts of the user; and
the method further comprises presenting data that indicates a number of conversations determined for each of the plurality of contacts of the user.

34. A method of claim 29, wherein:
the first conversation is one of a plurality of conversations with the first contact; and
the method further comprises presenting data that indicates each conversation of the plurality of conversations with the first contact.

35. A method of claim 29, wherein:
the method further comprises determining a semantic vocabulary and topics based on a library of strings; and
determining the first semantic content and the second semantic content is based, at least in part, on the semantic vocabulary and topics.

36. A method of claim 29, wherein determining the first conversation portion and the second conversation portion based at least in part on time separations between successive strings further comprises performing hierarchical cluster analysis on the time separations.

37. A method of claim 29, wherein determining whether to merge the first conversation portion and the second conversation portion further comprises determining a similarity threshold based, at least in part, on performing hierarchical cluster analysis on differences in semantic content of successive conversation portions.

38. A method of claim 29, wherein determining whether to merge the first conversation portion and the second conversation portion further comprises determining a similarity threshold based, at least in part, on performing hierarchical cluster analysis on differences in a correlation value that is based on a combination of semantic content differences and temporal differences of successive conversation portions.

39. An apparatus comprising:
at least one processor; and
at least one memory including computer program code for one or more programs,
the at least one memory and the computer program code configured to, with the at least one processor, cause the apparatus to perform at least the following,
determining from a first plurality of strings associated at least in part with a first contact of a user, based at least in part on time separations between successive strings, a first conversation portion that comprises a plurality of strings of the first plurality and a different second conversation portion that comprises a different plurality of strings of the first plurality;
determining a first semantic content for the first conversation portion and a second semantic content for the second conversation portion; and
determining whether to merge the first conversation portion and the second conversation portion into a first conversation that includes the first conversation portion based, at least in part, on a similarity of the first semantic content to the second semantic content.

40. An apparatus of claim 39, wherein to determine whether to merge the first conversation portion and the second conversation portion further comprises to combine the first conversation portion and the second conversation portion into the first conversation, if the similarity is determined to exceed a similarity threshold.

41. An apparatus of claim 39, wherein the apparatus is further caused to determine a first conversation label for the first conversation based, at least in part, on a semantic topic for the first semantic content.

42. An apparatus of claim 39, wherein the apparatus is further caused to present data that indicates the first conversation label, and wherein the apparatus is further caused to present data that indicates the first conversation portion in association with the first conversation label.

43. An apparatus of claim 39, wherein the strings associated at least in part with the first contact are derived from one or more instant messaging messages or one or more short message service messages or one or more metadata fields for content exchanged with the first contact, or some combination.

44. An apparatus of claim 39, wherein:
the first contact is one of a plurality of contacts of the user; and
the apparatus is further caused to present data that indicates a number of conversations determined for each of the plurality of contacts of the user.

45. An apparatus of claim 39, wherein:
the first conversation is one of a plurality of conversations with the first contact; and
the apparatus is further caused to present data that indicates each conversation of the plurality of conversations with the first contact.

46. An apparatus of claim 39, wherein:
the apparatus is further caused to determine a semantic vocabulary and topics based on a library of strings; and
to determine the first semantic content and the second semantic content is based, at least in part, on the semantic vocabulary and topics.

47. An apparatus of claim 39, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

48. A computer program product including one or more sequences of one or more instructions which, when executed by one or more processors, cause an apparatus to perform at least a method comprising:
determining from a first plurality of strings associated at least in part with a first contact of a user, based at least in part on time separations between successive strings, a first conversation portion that comprises a plurality of strings of the first plurality and a different second conversation portion that comprises a different plurality of strings of the first plurality;
determining a first semantic content for the first conversation portion and a second semantic content for the second conversation portion; and
determining whether to merge the first conversation portion and the second conversation portion into a first conversation that includes the first conversation portion based, at least in part, on a similarity of the first semantic content to the second semantic content.
